(19) United States
(12) Patent Application Publication
(10) Pub. No.: US 2019/0151992 A1
(43) Pub. Date: May 23, 2019

(54) LASER MARKING SYSTEM WITH THROUGH-THE-LENS AUTOFOCUS

(71) Applicant: Videojet Technologies Inc., Wood Dale, IL (US)

(72) Inventors: Christopher BAHNS, Westford, MA (US); Faycal BENAYAD-CHERIF, Lexington, MA (US)

(21) Appl. No.: 16/315,074

(22) PCT Filed: Jul. 5, 2017
(86) PCT No.: PCT/US2017/040670

§ 371 Date: Jan. 3, 2019

Related U.S. Application Data
(60) Provisional application No. 62/358,320, filed on Jul. 5, 2016.

(51) Int. Cl. B23K 26/362; G05B 19/18; B23K 26/03; B23K 26/046; B23K 26/06; B23K 26/082; B23K 26/40; B23K 26/70

(52) U.S. Cl. CPC B23K 26/362; G05B 19/182; B23K 26/032; B23K 26/046; G05B 2219/36199; B23K 26/0648; B23K 26/0821; B23K 26/40; B23K 26/702; B23K 26/0643

(57) ABSTRACT

The embodiments include a system, comprising: a scanhead with a marking laser having a marking field. The system includes a vision system having a camera embedded in the scanhead having a field of view (FOV) within the marking field and an autofocus module which uses pixel information in an in-focus region of interest (ROI) of a target surface of a part to obtain a Z-axis focus in a vertical dimension above a two-dimensional (2D) plane. The marking laser selectively marks with a laser beam the target surface in the marking field based on at least the Z-axis focus.

### BACKGROUND

The embodiments relate to a laser marking system with through-the-lens autofocus capability.

Some laser marking systems feature a focusing technique on a laser beam using a triangulation or beam spot size. These systems typically focus on a single point. Because these solutions rely on a beam reflection, they perform poorly on shiny or translucent surfaces.

Some known systems finding the laser focus on a part to be marked by performing manual calculations and measurements. Existing manual processes can take from 3 min to 15 min per part without a guaranteed focus on the target surface like the inside of a cavity.

### SUMMARY

Embodiments herein relate to a method, system and non-transitory, tangible computer-readable storage medium for conducting autofocus along a Z-axis using a through-the-lens vision system.

The embodiments include a system, comprising: a scanhead with a marking laser having a marking field. The system includes a vision system having a camera embedded in the scanhead having a field of view (FOV) within the marking field and an autofocus module which uses pixel information in an in-focus region of interest (ROI) of a target surface of a part to obtain a Z-axis focus in a vertical dimension above a two-dimensional (2D) plane. The marking laser selectively marks with a laser beam the target surface in the marking field based on at least the Z-axis focus.

An aspect of the embodiments includes a method, comprising: determining a focus point on a target surface of a part in a region of interest (ROI) by a vision system of a laser marking system having an autofocus module which uses pixel information to obtain a Z-axis focus in a vertical dimension above a two-dimensional (2D) plane; automatically adjusting, by a controller of the laser marking system, to the focus point in a scanhead of the laser marking system based on the Z-axis focus on the target surface of the part; and marking, with a laser beam produced by a laser in the scanhead of the laser marking system, a mark on the target surface of the part based on at least the Z-axis focus.

Another aspect of the embodiments includes a tangible, non-transitory computer readable medium having instructions stored thereon which when executed by at least one processor causes the at least one processor to: determine a focus point on a target surface of a part, by a vision system of a laser marking system, in a region of interest (ROI) using pixel information to obtain a Z-axis focus wherein the Z-axis focus is in a vertical dimension above a two-dimensional (2D) plane; cause, by a controller, adjustment to the focus point in a scanhead of the laser marking system based on the Z-axis focus on the target surface of the part; and cause marking, by a laser in the scanhead of the laser marking system, a mark on the target surface of the part with a laser beam based on at least the Z-axis focus.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1A illustrates a block diagram of a laser marking system;

FIG. 1B illustrates a block diagram of another laser marking system;

FIG. 2 illustrates a block diagram of a method for selecting and sizing a region of interest (ROI);

FIG. 3 illustrates a block diagram of a method for determining a focus peak;

FIG. 4 illustrates a graphical user interface for selecting and sizing a region of interest (ROI) on a part for starting an autofocus operation and a camera view window;

FIG. 5 illustrates a graphical representation of a peak focus level curve, a joint photographic experts group (JPEG) compression curve, and a portable network graphics (PNG) curve;

FIG. 6A illustrates a graphical representation of a JPEG compression focus curve for a part with a first plurality of sample points for a coarse high search state;

FIG. 6B illustrates a graphical representation of a JPEG compression focus curve for a part with a second plurality of sample points for a coarse middle search state;

FIG. 6C illustrates a graphic representation of a JPEG compression focus curve for a part with a third plurality of sample points for a coarse low search state;

FIG. 6D illustrates a graphic representation of a JPEG compression focus curve for a part with a fourth plurality of sample points for a fine low search state;

FIG. 6E illustrates a graphic representation of a JPEG compression focus curve for a part with a fifth plurality of sample points for a fine high search state;

FIG. 6F illustrates a graphic representation of a JPEG compression focus curve for a part with a calculated focus peak;

FIG. 7 illustrates a block diagram of a computing device; and

FIG. 8 illustrates a block diagram of the through-the-lens (TTL) autofocus module.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Most autofocus systems focus on a specific area of the marking field using a laser beam and rely on triangulation. The system of the embodiments described herein does not use a laser beam but instead image processing techniques which allows a scanhead to focus along a Z-axis using pixel information. This allows the system to focus on anything the camera device can see, such as the inside of a cavity as small as the eye of a needle or a scratch on piece of glass.

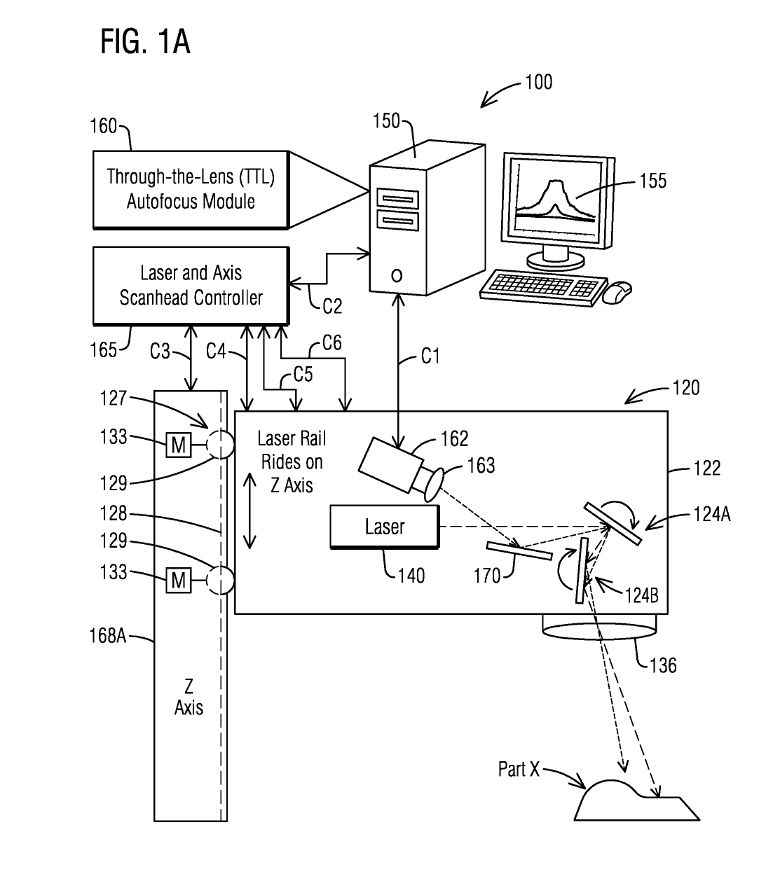

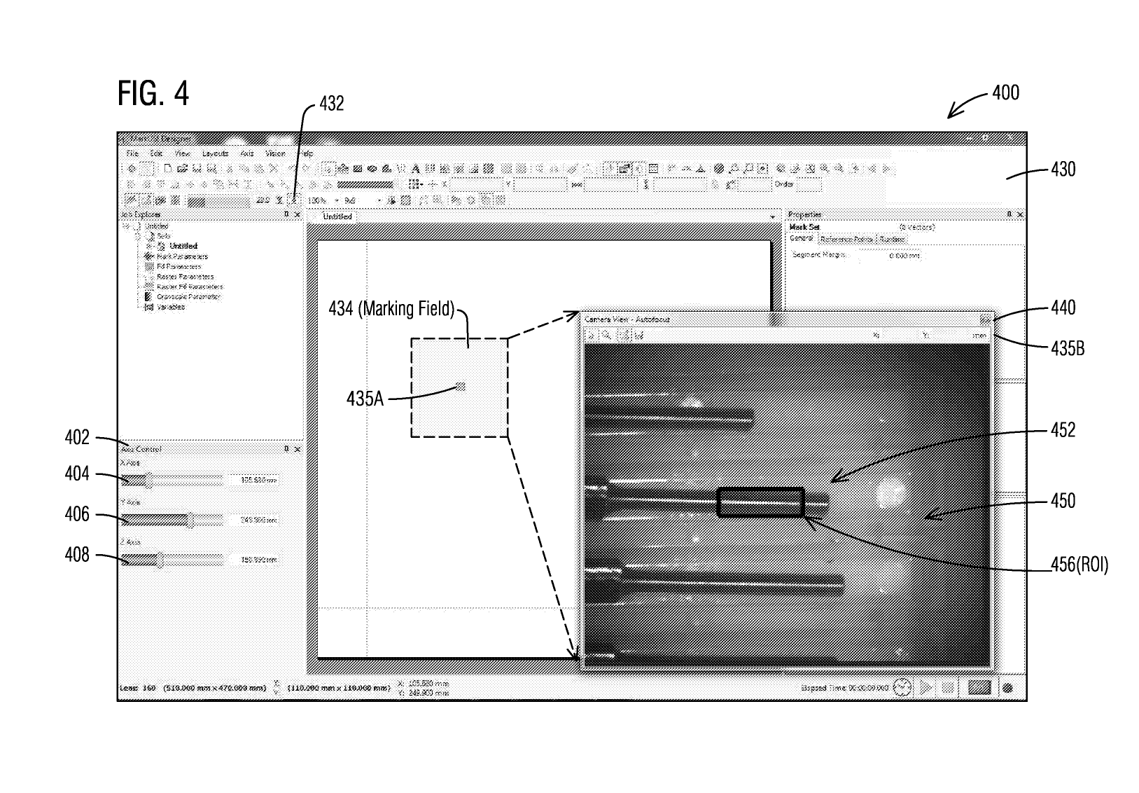

FIG. 1A illustrates a block diagram of a laser marking system 100. The laser marking system 100 may comprise a marking scanhead 120, laser 140 and through-the-lens (TTL) vision system comprising a through-the-lens autofocus module 160 and camera device 162. The scanhead 120 may include galvo mirrors 124A and 124B and lens 136 (i.e., first lens). By way of non-limiting example, the lens 136 may be an F-theta focusing lens. The galvo mirrors 124A and 124B include X and Y mirrors and galvanometers. In operation, the galvo mirrors 124A and 124B are angularly adjustable to allow a laser beam from the laser 140 to mark a part X anywhere within a marking field (i.e., marking field 434 in FIG. 4).

Laser marking system 100 may employ a non-contact printing method providing mark quality and permanence. The laser marking system may include CO₂, Fiber and ultraviolet (UV) laser sources in different power outputs to address a range of substrates and applications. The CO₂ laser sources may include laser sources having a power of 10 W, 30 W or 50 W. The laser marking system 100 being configured to apply a code having one or more of a serial number, time, date and lot codes. The laser marking system 100 may be configurable to apply a code in a particular code format including without limitation according to an industry standard code format.

By way of non-limiting example, the laser 140 may be an infrared (IR) laser.

The through-the-lens (TTL) vision system may comprise a camera device 162 which may be embedded in the marking scanhead 120 to capture images of the part X through the F-theta lens 136 and TTL mirror 170. The camera device 162 may include a fixed focus lens 163 (i.e., second lens). The TTL mirror 170 is in a path to receive reflections of the galvo mirrors 124A and 124B. In operation, by moving the galvo mirrors 124A and 124B, the camera view of camera device 162 may be directed at any area within the marking field (i.e., marking field 434 in FIG. 4) until the part X is in the field of view (FOV) of the camera device 162. The TTL mirror 170 may be a dichroic mirror.

In an embodiment, the beam path of laser 140 may be directed to the galvo mirrors 124A and 124B. However, the beam path of the laser 140 bypasses the mirror 170 such that the beam path of the laser 140 is not reflected from the mirror 170 of the TTL vision system.

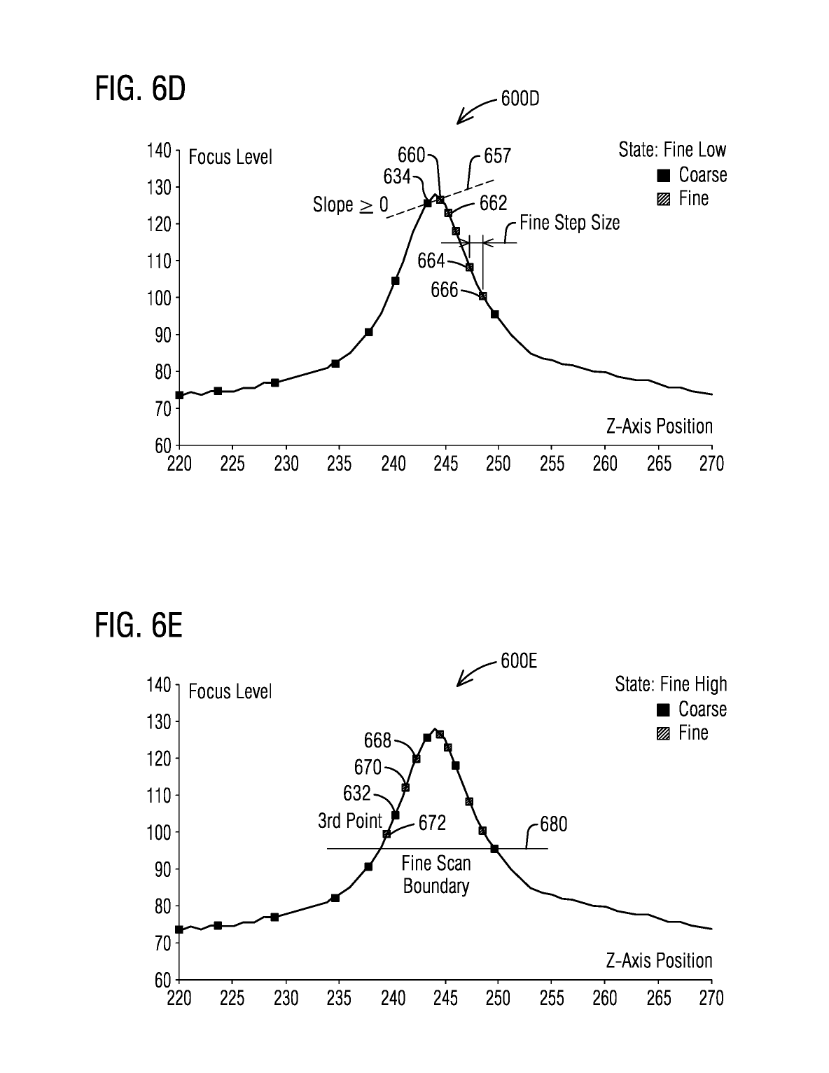

The system 100 may further comprise a processor or computing device 150 configured to perform an autofocus procedure and system calibration procedures to ensure that the focus point of the camera device 162 matches the focus point of the marking laser 140. The computing device 150 will be described in more detail in relation to FIG. 7. The controller 165 controls, via control line C6, the activation of the laser 140 to mark with a laser beam the part X. The laser control may be part of the computer device 150.

Specifically, a deviation from the ideal camera focus point, in FIG. 1A is reflected with a corresponding deviation in the laser focus. The camera device 162 may be embedded in the laser 140 which shares galvo mirrors 124A and 124B with laser 140. The galvo mirrors 124A and 124B allow the camera device 162 to find focus on the majority of the marking field (i.e., marking field 434 in FIG. 4) through the lens 126. The camera's beam path is represented as the short-dashed line. The laser beam path is represented as the long-dashed line. The camera device 162 may communicate with computing device 150 via control lines C1 and the autofocus module to capture the image of the target surface of the part. The captured image may be a camera view image. The communications between the camera device 162 and the computing device may be conducted over control line C1 but may also be wireless.

The system 100 may further comprise a laser and axis scanhead (L&AS) controller 165 and an adjustable Z-axis platform 168A. The housing 122 of the scanhead 120 and the Z-axis platform may be interfaced together by a rail assembly 127 denoted as arrows. The rail assembly 127 may allow the scanhead housing 122 to move along a Z-axis to adjust a focus of laser 140 through lens 136. The movement in the Z-axis may be linear in a back and forth manner or up and down manner. The movement by the rail assembly 127 may be caused by servo motors (M) 133 to cause at least one wheel 129 to rotate in a clockwise or counterclockwise manner along a rail or track 128. In other embodiments, the movement may include a slide mechanism or linear actuator moved by push and pull motions.

The rail assembly 127 may include a track 128 which is vertically oriented. The scanhead housing 122 may include wheels 129 or another interface to engage and move along the track 128. In some embodiments, the interface (wheel to track) may include a rack and pinion configuration or gears moved by the servo motors, etc.

The L&AS controller 165 may communicate with computing device 150 to receive the autofocus control signals C2. Based on the autofocus control signals C2, the L&AS controller 165 causes the rail assembly to be move by an amount and in a direction in accordance with the control signals C3. While lines are shown for control signals C1, C2, C3, C4, C5 and C6, such signals in some embodiments may be wireless. The controller 165 may be a single controller or multiple controllers. For example, there may be one controller to operate the laser 140 and a separate and independent controller to operate the rail assembly.

The TTL autofocus module 160 of the TTL vision system may include a one-click function for finding the focus position automatically by moving the Z-axis and taking focus measurements at different positions. By way of non-limiting example, in some embodiments, in less than 30 seconds (from a reasonable starting point), the user may get the laser 140 focused on any part surface of part X within the laser marking field (i.e., marking field 434 in FIG. 4). The TTL autofocus module 160 may include tools for identifying a Region of Interest (ROI) and an autofocus ROI editor. The ROI is a user-specified targeting of any surface on the part X which is to be marked. The TTL autofocus module 160 may include a focus measurement level. The focus measurement level is at its highest where the focus is best, and lower everywhere else. The TTL autofocus module 160 may include finding a focus peak via a focus peak determination algorithm. An efficient and repeatable approach to finding focus by discrete Z-axis movements and making decisions based on relative focus measurements.

The TTL vision system may allow for the precise selection of an area of the part where focus is desired. The focus measurement considers only this area and ignores all other parts of the image, as will be described in more detail in relation to FIG. 4. Once the part X is in place, the autofocus ROI editor makes it easy to select the desired part surface on which to find the focus. In production, the system 100 may be focused using the autofocus processes described herein such as for a plurality of similar type parts. Similar parts may be of the same size and placed in the same orientation on a surface. The surface in some embodiments may move so that parts are moved in and out of the marking field automatically.

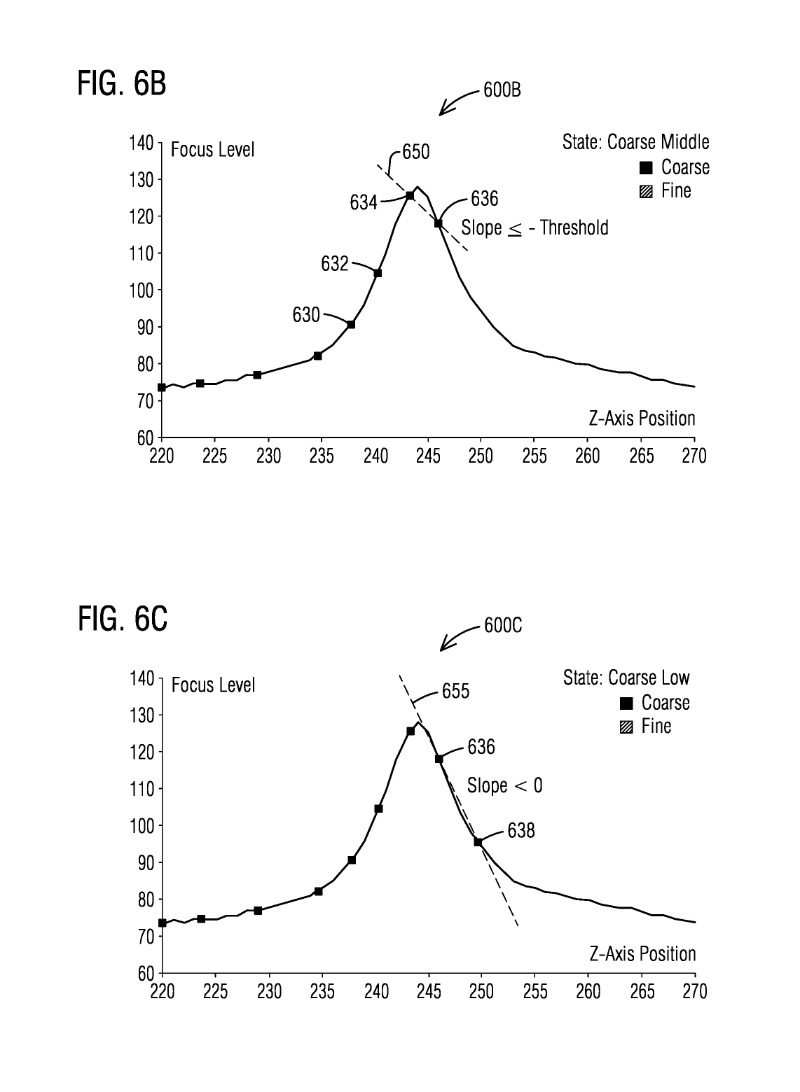

A good focus measurement has its maximum value where the focus level is best, and then decreasing rapidly while moving away from this position, as seen in FIGS. 6A-6F.

Laser 140 may use an optical Z-axis which may include a moving lens that simulates a Z axis motion of the rail, as shown in FIG. 1B.

Referring now to FIG. 4, the graphical user interface 430 of FIG. 4 may be configured to display a first window on a display screen 155. The first window may display in display screen 155 a graphical representation of a marking field 434 of the laser 140, the marking field 434 includes an image of the part. The laser 140 may be configured to apply the mark anywhere in the marking field 434.

The system via GUI 430 is configured to display in display screen 155 a second window representative of an image of a camera view 435A within a marking field 434 wherein moving the camera view within the marking field 434 causes mirrors 124A and 1248 in the scanhead 120 to move such that the part is within the image of the camera view. The camera view image may be generated by the autofocus module.

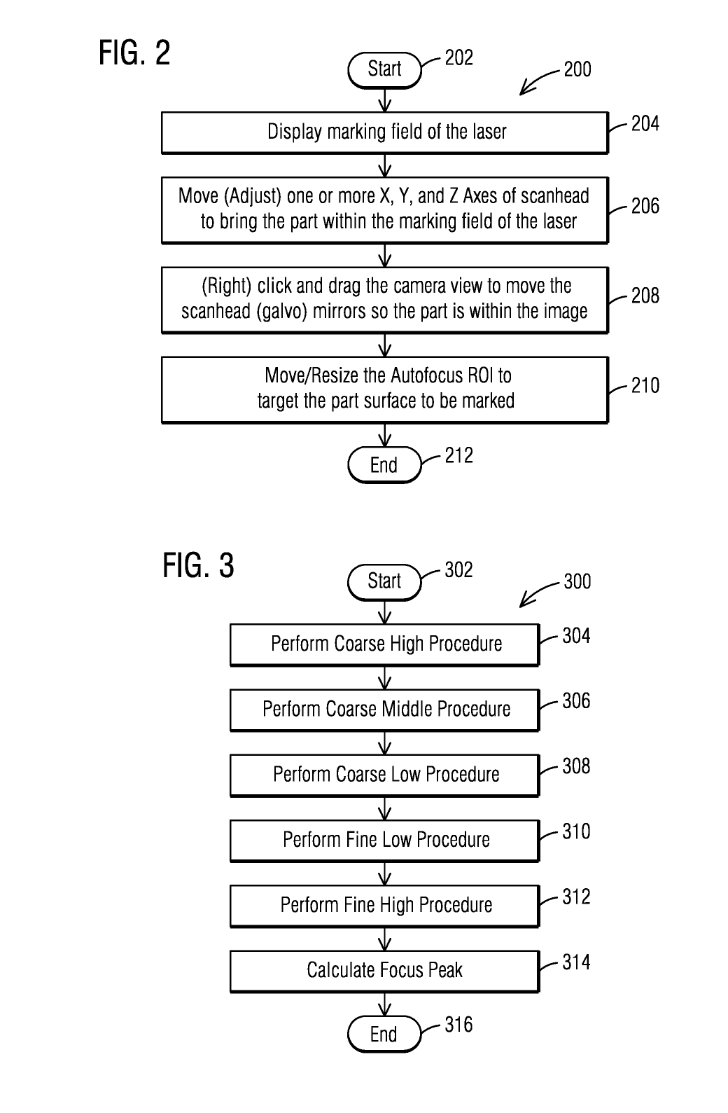

The system via GUI 430 is configured to receive selection, adjustment or sizing of a user-identified region of interest (ROI) 456 on the target surface of the part within the image of the camera view displayed on display screen 155 in the second window. The autofocus module may perform image compression of the user-identified ROI 456 to obtain the Z-axis focus relative to the target surface using a focus peak determination algorithm (FIG. 3).

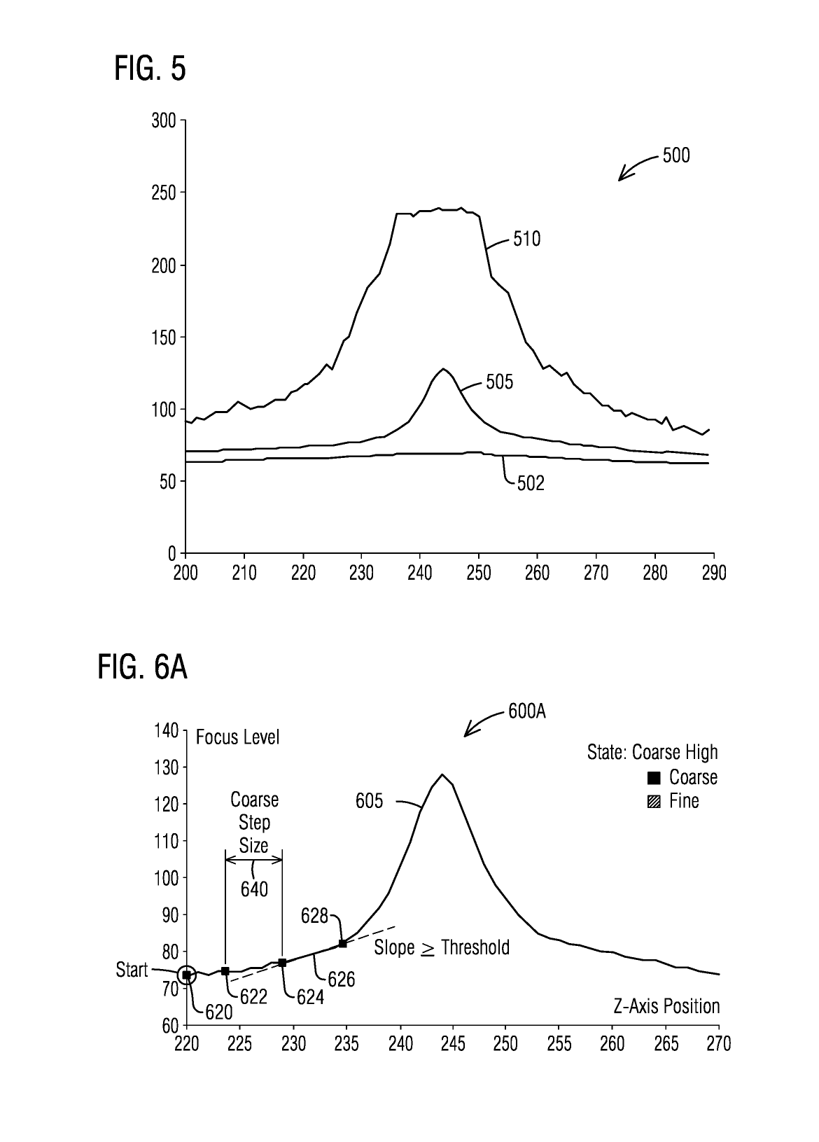

FIG. 5 illustrates a graphical representation 500 of a peak focus level curve having a Z-axis position on the horizontal axis of the graph and a focus level on the vertical axis of the graph. The peak focus level curve 510 is contrasted with a joint photographic experts group (JPEG) compression curve 505, and a portable network graphics (PNG) curve 502. JPEG compression curve 505 has been shown to have this characteristic with a wide variety of materials, including dark gray/black, shiny, translucent, and reflective surfaces. The measured focus level using the JPEG compression is normalized by dividing the size of the compressed image by the size of the uncompressed image.

The curves 502, 505 and 510 show the relationship between the Z-axis position (horizontal) and focus level (vertical), for three different measurement techniques (scaled for comparison). The peak focus level curve 510 approach takes the difference between the brightest and darkest grayscale pixel values in the image. The PNG curve 502 approach uses a different type of compression. The data indicates that, while the JPEG compression curve 505 is likely to produce the same focus position each time, the “Peak” curve 510 approach has a wide plateau (10 to 20 mm) where the focus position might be found (but may not be repeatable). The PNG compression curve approach probably would not find a peak.

Each curve 502, 505 and 510 is created for a ROI beginning with a Z-axis position starting for example at Z-axis position 200 and adjusted until Z-axis position 290. At each position or other incremental steps, a focus measurement is taken. The peak focus level curve 510 was generated by calculating the difference between the brightest and darkest grayscale pixel values in the ROI of the image for each Z-axis position and increments along the Z-axis until approximately a Z-axis position of 290. For the JPEG compression curve 505, the measured focus level is generated by using JPEG compression image data in a ROI normalized by dividing the size of the compressed image in the ROI by the size of the uncompressed image in the ROI, for each Z-axis position and in increments along the Z-axis until approximately a Z-axis position of 290. The curves shown are measured curves.

As can be appreciated, different Z-axis positions may be used as the size of the part changes.

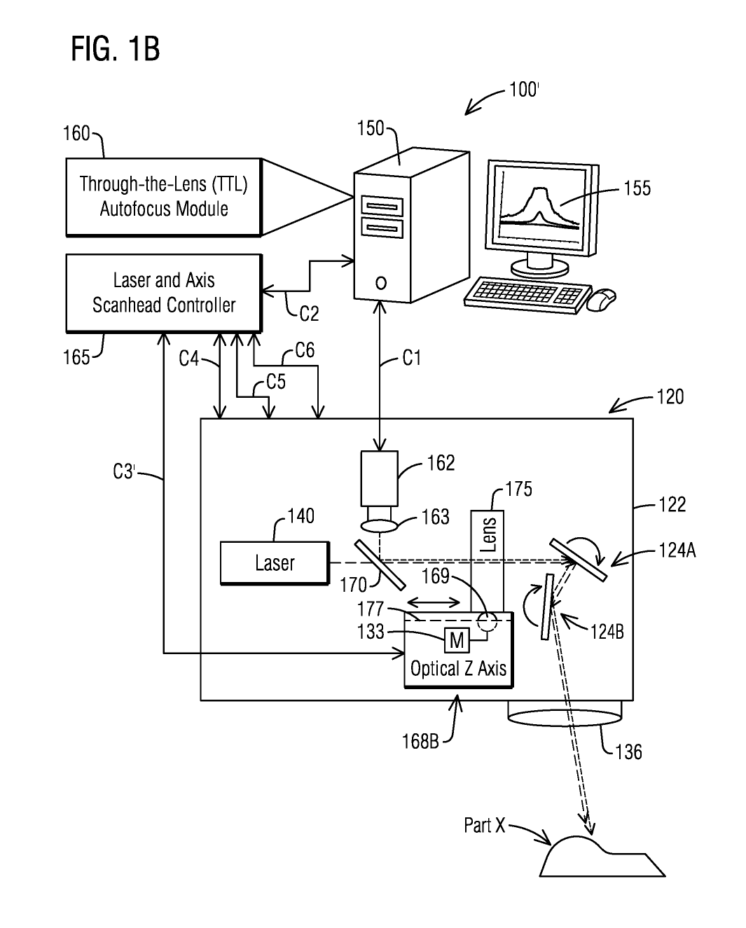

FIG. 2 illustrates a block diagram of a method 200 for selecting and sizing a region of interest (ROI). One or more of the blocks may be performed in the order shown or in a different order and/or contemporaneously. One or more blocks may be added or deleted. The method 200 will be described in relation to FIG. 4. FIG. 4 illustrates an autofocus graphical user interface (GUI) 430 of the TTL autofocus module 160 for selecting a camera view 435A within a marking field 434. The marking field 434 is represented in a dashed block.

The camera view 435B (an enlarged view of the camera view 435A) in a camera view window 440 may be displayed on display screen 155 in response to selecting the camera view 435A from the marking field 434. The camera view 435B also includes region of interest (ROI) 456 and ROI selection tool, shown on a part 452, for starting an autofocus operation within the ROI 456 in the camera view window 440 shown overlaid on the autofocus GUI 430. The ROI 456 is shown as a rectangle or box outline. The ROI 456 being within the area bounded by the rectangle or box outline. The rectangle or box outline being controlled by ROI selection tool in the autofocus module 160. The ROI selection tool controls the rectangle or box outline so that it may be enlarged or reduced in size such as by clicking on a corner and moving inward to reduce the area or moving outward to enlarge the area. The ROI location may also be moved within the camera view 435B by moving the ROI 456 to a new location such as by dragging.

Tool 432 on the autofocus GUI 430 displays the camera view window 440 on display screen 155. The method 200 may begin at block 202. At block 204, the method 200 displays a marking field 434 in FIG. 4 of the laser 140. At block 206, the module 160 allows the user to move or adjust one or more of X, Y or Z axes of the scanhead 120 by bringing the part 452 within the marking field 434 in FIG. 4 of the laser 140. As shown in FIG. 4, an axis control graphical user interface (GUI) 402 is shown. The axis control GUI 402 includes controls 404, 406 and 408 to individually and selectively control each adjustable axis of the scanhead 120. Control 404 controls the X-axis of the scanhead 120. Control 406 controls the Y-axis of the scanhead 120. Control 408 controls the Z-axis of the scanhead 120. The controls 404, 406 and 408 may serve to adjust a camera view within the marking field 434 to a different location within the marking field 434. The X-axis and Y-axis move the camera view in a two-dimensional (2D) plane. The Z-axis being a vertical dimension above a 2D plane.

The ROI 456 is a subset of the camera view image used to perform image compression. This area of the ROI 456 can be positioned anywhere in the camera image and the camera image can be placed anywhere in the marking field 434 of the system 100.

The marking field 434 is the largest area accessible by the laser 140 to mark. The marking field 434 is defined by the maximum displacement of the mirrors (galvo mirrors) inside the scanhead 120.

FIG. 1B illustrates a block diagram of another laser marking system 100′. The system 100′ is similar to system 100. Therefore, for the sake of brevity, only the differences will be described. Laser 140 may use an optical Z-axis which may include a moving lens 175 (i.e., a third lens) that simulates a Z axis motion of the rail, as shown in FIG. 1B. Thus, in lieu of a rail system, the Z-axis motion is controlled by Z-axis lens motion platform controller 168B to control a platform configured to move the moving lens 175 along the optical axis (back and forth) between the laser 140 and the galvo mirrors 124A and 124B. The moving lens 175 is shared by both the camera 162 and the laser 140. The optical axis platform controller 168B includes a rail or track 177 configured to interface with wheel 169 couple to the moving lens 175. The controller 165 controls the optical axis platform controller 168B via control signals C3′. The control signals C3′ may indicate the amount of movement of the moving lens 175 along the optical axis.

In an embodiment, in lieu of an optical axis platform controller 168B with a track and a wheel coupled to the moving lens, the lens 175 may be a liquid lens which is controlled by control signals C3′ such that the optical axis is changed to effectuate a change in the Z-axis focus.

In FIG. 1B, the mirror 170 is in-line to receive a beam path of laser 140. Furthermore, the mirror 170 is in-line with the moving lens 175 wherein moving lens 175 is between the mirror 170 and the galvo mirrors 124A and 124B.

At block 208, the user may (right) click and drag the camera view to move the scanhead (or galvo mirrors) so the part 452 is within the displayed image 450 in the camera view window 440. The galvo mirrors 124A and 124B are controlled by control lines C4 and C5, respectively. In FIG. 4, the part 452 is shown in the camera view window 440. At block 210, the user may move or resize the autofocus ROI 456 to target the part surface to be marked. At block 212, the method 200 may end.

By way of non-limiting example, the ROI 456 is resized by clicking on a corner of it or one of the sides and dragging the mouse. It is moved by clicking in the center of the square and dragging it, for example.

When the autofocus process is started, it searches up to a configurable distance from the current Z-axis position. If a peak is not found in that range, then it exits with failure.

FIG. 3 illustrates a block diagram of a method 300 for determining a focus peak in the Z-axis, the method being a focus peak determination algorithm. While searching, the process transitions through multiple search-states. Within each state, a specific condition triggers the transition to the next state. The search states begin at block 302. At block 304, the method 300 performs a search using a coarse high procedure, as will be described in more detail in relation to FIG. 6A. In view of the description herein, different search techniques may be used to find the focus point or the focus peaks using the pixel information and should not be limited to the specific description set forth herein.

At block 306, a search using a coarse middle procedure is performed, as will be described in more detail in relation to FIG. 6B. At block 308, a search using a coarse low procedure is performed, as will be described in more detail in relation to FIG. 6C. At block 310, a search using a fine low procedure is performed, as will be described in more detail in relation to FIG. 6D. At block 312, a search using a fine high procedure is performed, as will be described in more detail in relation to FIG. 6E. At block 314, the focus peak (focus point) is calculated, as will be described in more detail in relation to FIG. 6F. After the focus point has been found successfully, the Z-axis is moved one final time to the calculated focus point. As can be seen, autofocus can take place over the entire marking field 434 in FIG. 4. Moreover, the user does not have to measure the height of the part to bring the laser 140 in focus onto the part surface. By combining the use of the galvo mirrors with thru-the-lens camera images, the system 100 is able to focus on any area of the marking field 434 in FIG. 4.

FIG. 6A illustrates a graphical representation of a JPEG compression focus curve 600A for a part with a first plurality of sample points 620, 622, 624, and 628 for a coarse high search state (block 304). The JPEG compression curves in FIGS. 6A-6F are expected curves and not actually formed by the technique. The curves are shown for illustrative purposes, as in general, the focus level measurements are taken at specific increments along the Z-axis as described below. If points of focus level measurement are taken at sufficiently small increments along the Z-axis, the curves in FIGS. 6A-6F would generally be formed. In an embodiment, a JPEG compression technique described above in relation to FIG. 5 may be used. In other embodiments, the peak level technique may be used.

The method includes generating a first step or sample point 620 which may be 1/2 the coarse step size (in case of starting near the peak), followed by full coarse steps until the slope threshold is reached. Distance 640 represents the coarse step size which corresponds to a change in the Z-axis position. The sample point 620 is a starting sample point. Sample points 622, 624 and 628 are selected along Z-axis (which tends to follow the JPEG compression focus curve 600A), each point at a coarse step size distance from the other at a different Z-axis position. In another example, more or less sample points may be generated. The measured focus is a function of the JPEG compression of the image in the ROI for the Z-axis position.

The method, for each two adjacent points along the Z-axis evaluates a slope parameter. If the slope parameter is greater than or equal to a first threshold, the method 300 transitions from the Coarse High Procedure at block 304 to the Coarse Middle Procedure at block 306. In this example, the slope between points 624 and 628 along line 626 has a slope greater than or equal to the first threshold.

FIG. 6B illustrates a graphical representation of a JPEG compression focus curve 600B for a part with a second plurality of sample points 630, 632, 634 and 636 for a coarse middle search state (block 306). In some embodiments, the method proceeds with 1/2 coarse size steps along the Z-axis until the negative of the slope threshold (or second threshold) is reached.

The second plurality of sample points 630, 632, 634 and 636 may not be marked as 1/2 coarse size steps and may include other points not shown. As illustrated, points 634 and 636 are on opposite sides of the expected peak curvature shown. As can be appreciated, the method intends to find the “peak curvature” along the Z-axis. Hence, as referenced previously, the curve 600B is for illustrative purposes to illustrate what is expected when finding a peak focus level at various positions along the Z-axis.

Each two adjacent points along the Z-axis (represented on curve 600B) selected from the second plurality of sample points are evaluated by the method for a slope parameter. If the slope parameter is less than or equal to a second threshold, the method 300 transitions from the Coarse Middle Procedure at block 306 to the Coarse Low Procedure at block 308. In this example, the slope between points 634 and 636 along line 650 has a slope less than or equal to the threshold. In some embodiments, the “second threshold” of the Coarse Middle Procedure is a negative threshold which represents a turn over the peak of the peak curvature.

FIG. 6C illustrates a graphic representation of a JPEG compression focus curve 600C for a part with a third plurality of sample points 636 and 638 for a coarse low search state (block 308). In an embodiment, the method may take only one 1/2 coarse size step along the Z-axis from sample point 636 to create sample point 638. Then the slope between sample points 636 and 638 are evaluated. If the slope is still negative, then the method transition to the Fine Low state (block 310). Otherwise, the method returns to the Coarse Middle Procedure (block 306).

The two sample points of the third plurality of sample points 636 and 638 are evaluated for a slope along line 655. The slope may be evaluated to determine if the slope is greater than zero. Nonetheless, other thresholds may be used.

FIG. 6D illustrates a graphic representation of a JPEG compression focus curve 600D for a part with a fourth plurality of sample points 634, 660, 662, 664, and 666 for a fine low search state (block 310). The method scans in the opposite direction with fine size steps in the Z-axis marking a plurality of sample points. The method skips over any coarse points along the Z-axis already found and proceeds until the slope becomes positive again between any two sample points of the fourth plurality of sample points. In the example, points 634 and 660 have a positive slope along line 657 between the points 634 and 660. Once the slope becomes positive, the method 300 transitions to block 312.

FIG. 6E illustrates a graphic representation of a JPEG compression focus curve 600E for a part with a fifth plurality of sample points for a fine high search state (block 312). The method continues scanning in the opposite direction along the Z-axis with fine size steps. The method may skip over any coarse points on the Z-axis already found. The method may stop after three sample points 668, 670, and 672 or the measured focus level drops below that of the last coarse point 632. The method marks a fine boundary at line 380. The fine sample points reside above the fine boundary 380 on both side of the peak of the curve 600E.

FIG. 6F illustrates a graphic representation of a JPEG compression focus curve 600F for a part with a calculated focus peak (block 314). The method may take at most the top seven measured points above boundary 380 along the Z-axis that have been gathered and find the best-fit second order polynomial to those points. These points which are selected are shown in circle 390. These points may generally be referred to as the peak focus curve. The focus point along the Z-axis is where the slope of the polynomial is zero (maximum) on the peak focus curve.

The system 100 provides an ability to focus on any surface: Because of the use of the image processing approach an infinite variety of materials, ranging from dark surface to translucent or reflective materials, can be focused on in a matter of seconds. Current commercial systems cannot focus on reflective surfaces like glass or mirror like finishes. The ability to focus on any surface using the galvo positioning of the scanhead to reach any area of the marking field 434 in

FIG. 4 allows a greater variety of parts to be marked. The galvo positioning is controlled by control lines C4 and C5.

The system provides for multiple starting points where the focus point can be found to within 0.1 mm (millimeter) on most materials. The system has an ability to focus on arbitrary closed shapes: The image processing solution allows the system to focus on any closed shaped surface including a ring with an excluded center. Most commercial systems use a round spot.

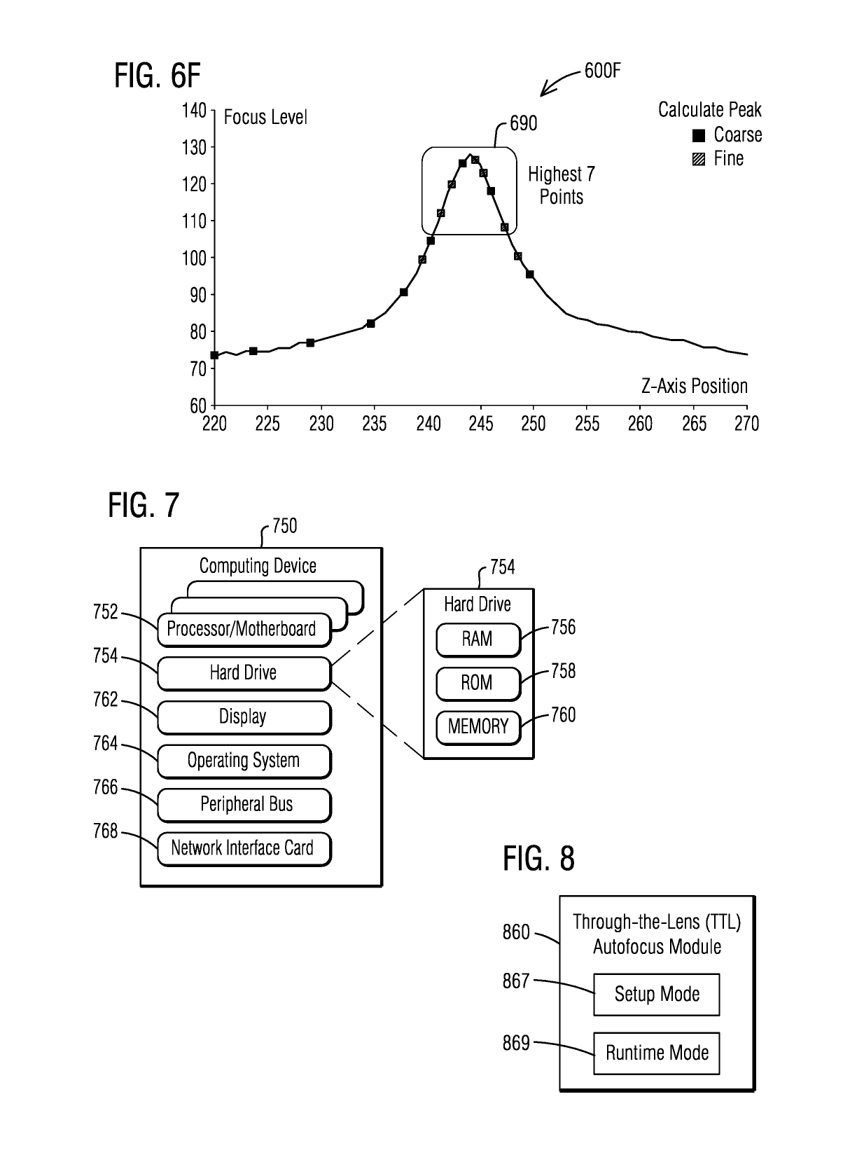

FIG. 8 illustrates a block diagram of the through-the-lens (TTL) autofocus module 860. TTL autofocus module 860 (i.e., TTL autofocus module 160) may include a setup mode module 867 and a runtime mode module 869.

In some embodiments, the laser 140 is selectively activated by a user or at runtime, via the computing device 150, through the controller 165 for each part X to be marked with the laser beam at a particular Z-axis focus. The part X may be included in a batch of the same parts of like size and height. In some embodiments, the part X may be one part of a group of parts of like size and height to be marked during runtime of the system. Thus, in the setup mode, the setup mode module 867 allows the Z-axis focus to be stored in memory (FIG. 7) for use by the laser 140 when marking parts X of the batch or the group during the system's runtime.

In some embodiments, the stored Z-axis focus determined during the setup mode is used for marking during the system's runtime wherein the Z-axis focus is retrieved from memory. Because of tolerance variations in manufacturing, the Z-axis focus may be in focus, slightly out of focus or within an acceptable range of focus for the Z-axis focus.

During the setup mode, the setup mode module 867 may allow the user to determine a plurality of different Z-axis focuses and each different Z-axis focus may be stored for use during the runtime of the system. For example, different Z-axis focuses may be pre-stored for use during system runtime for a particular batch or group or a single part X. The batch may be sorted by size such that each different Z-axis focus would correspond to a particular size, batch number or lot. In other embodiments, a single part may require more than one Z-axis focus to be determined for one or more marks to be applied at different locations such that each location may be associated with a different height or marks. In other words, a part X may have two marks applied by the laser marking system. Each mark may require its own Z-axis focus.

A runtime mode module 869 of the TTL autofocus module 860 may allow the system during runtime to establish a Z-axis focus for any single part X the system is currently in focus. Thus, the Z-axis focus may be determined for each part, every part or every M part where M is a number greater than 1. Therefore, the Z-axis focus may be re-determined during runtime every M many parts. By way of non-limiting example, the M many parts may be every 3^{rd} part, every 4^{th} part, etc.

In some embodiments, whether during setup mode or the runtime mode of the TTL autofocus module 860, a plurality of parts may be placed in discrete locations in the marking field 434. By way of non-limiting example, a part may be positioned in proximity to each of the four corners of the marking field. Other layouts may be used as well, such that part layouts are not limited to corner placement. Thus, in the setup mode, a Z-axis focus may be determined for each of a plurality of discrete locations using parts in the batch and store for recall from memory the location's Z-axis focus during runtime of the system when marking a part at a respective one discrete location. By way of further non-limiting example, parts in the marking field at discrete locations may have the same height or one or more parts in the marking field may have a different height from any of the other parts.

Hence, the Z-axis focus may be determined during setup or runtime for any part at any location in the marking field. During runtime mode of the TTL autofocus module 860, the Z-axis focus is selectively determined for one or more parts in the marking field during runtime of the system. The runtime of the TTL autofocus module 860 takes place during the runtime of the system. The setup mode of the TTL autofocus module 860 takes place prior to the runtime of the system.

Referring now to FIG. 7, in a basic configuration, the computing device 750 may include any type of stationary computing device or a mobile computing device. The computing device may be a computing system with one or more servers, each server including one or more processors. The term computing device and computing system may be interchangeable.

Computing device 750 may include one or more processors 752 and system memory in hard drive 754. Depending on the exact configuration and type of computing device, system memory may be volatile (such as RAM 756), non-volatile (such as read only memory (ROM 758), flash memory 760, and the like) or some combination of the two. System memory may store operating system 764, one or more applications, and may include program data for performing the processes 200 and 300 described herein. Computing device 750 may also have additional features or functionality. For example, computing device 750 may also include additional data storage devices (removable and/or non-removable) such as, for example, magnetic disks, optical disks, or tape. Computer storage media may include volatile and non-volatile, non-transitory, removable and non-removable media implemented in any method or technology for storage of data, such as computer readable instructions, data structures, program modules or other data. System memory, removable storage and non-removable storage are all examples of computer storage media. Computer storage media includes, but is not limited to, RAM, ROM, Electrically Erasable Read-Only Memory (EEPROM), flash memory or other memory technology, compact-disc-read-only memory (CD-ROM), digital versatile disks (DVD) or other optical storage, magnetic cassettes, magnetic tape, magnetic disk storage or other magnetic storage devices, or any other physical medium which can be used to store the desired data and which can be accessed by computing device. Any such computer storage media may be part of device.

Computing device 750 may also include or have interfaces for input device(s) (not shown) such as a keyboard, mouse, pen, voice input device, touch input device, etc. The computing device 750 may include or have interfaces for connection to output device(s) such as a display 762, speakers, etc. The computing device 750 may include a peripheral bus 766 for connecting to peripherals. Computing device 750 may contain communication connection(s) that allow the device to communicate with other computing devices, such as over a network or a wireless network. By way of example, and not limitation, communication connection(s) may include wired media such as a wired network or direct-wired connection, and wireless media such as acoustic, radio frequency (RF), infrared and other wireless media. The computing device 750 may include a network interface card 768 to connect (wired or wireless) to a network.

Computer program code for carrying out operations described above may be written in a variety of programming languages, including but not limited to a high-level programming language, such as Java, C or C++, for development convenience. In addition, computer program code for carrying out operations of embodiments described herein may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed Digital Signal Processor (DSP) or microcontroller. A code in which a program of the embodiments is described can be included as a firmware in a RAM, a ROM and a flash memory. Otherwise, the code can be stored in a tangible, non-transitory computer-readable storage medium such as a magnetic tape, a flexible disc, a hard disc, a compact disc, a photo-magnetic disc, a digital versatile disc (DVD).

The embodiments may be configured for use in a computer or a data processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart described herein in FIGS. 2-3. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps for creating a new machine. The general purpose computer becomes a special purpose computer once it is programmed to perform particular functions pursuant to instructions from program software of the embodiments described herein. The instructions of the software program that carry out the algorithm/steps electrically change the general purpose computer by creating electrical paths within the device. These electrical paths create a special purpose machine for carrying out the particular algorithm/steps. The computing device being part of a laser marking system configured to carryout the functions and operation of the laser marking system described herein.

Unless otherwise defined, all terms (including technical and scientific terms) used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In particular, unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such data storage, transmission or display devices.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

What is claimed is:

1. A system, comprising:
a scanhead with a marking laser having a marking field; and
a vision system having a camera embedded in the scanhead having a field of view (FOV) within the marking field and an autofocus module which uses pixel information in an in-focus region of interest (ROI) of a target surface of a part in the FOV to obtain a Z-axis focus in a vertical dimension above a two-dimensional (2D) plane
wherein the marking laser to selectively mark with a laser beam the target surface in the marking field based on at least the Z-axis focus.

2. The system of claim 1, wherein the vision system is a through-the-lens (TTL) vision system embedded with the making laser and further comprising:
a graphical user interface (GUI) configured to:
display a first window on a display screen, the first window to display a graphical representation of a marking field of the laser, the marking field including an image of the part and the laser is configured to apply the mark anywhere in the marking field;
display a second window of a camera view image from within the marking field wherein moving the camera view within the marking field causes mirrors in the scanhead to move such that the part is within the camera view image, the camera view image being generated by the autofocus module; and
receive selection, adjustment or sizing of a user-identified region of interest (ROI) on the target surface of the part within the camera view image displayed in the second window, wherein the autofocus module performs image compression of the user-identified ROI to obtain the Z-axis focus relative to the target surface using a focus peak determination algorithm.

3. The system of claim 1, wherein the autofocus module determines a joint photographic experts group (JPEG) compression value as a focus level value based on the pixel information along a plurality of different Z-axis positions; and determines a peak focus curve from the plurality of different Z-axis positions wherein the Z-axis focus corresponds to a peak focus point on the peak focus curve determined as a location where a slope of a polynomial is zero.

4. The system of claim 1, wherein the vision system determines the Z-axis focus based only on the pixel information.

5. The system of claim 1, wherein the scanhead includes at least two mirrors being shared by the marking laser and a camera of the vision system.

6. The system of claim 1, further comprising:
a scanhead housing configured to house the scanhead and the marking laser;
a Z-axis platform comprising a rail assembly coupled to the scanhead housing; and
a controller to cause movement of the rail assembly vertically wherein, in response to movement of the rail assembly, the Z-axis focus of the marking laser through the lens is adjusted relative to the 2D plane.

7. The system of claim 1, wherein the lens is a first lens; and further comprising:
a second lens having an optical axis shared by a camera of the vision system and the marking laser; and
a controller configured to control the optical axis of the second lens to adjust the Z-axis focus.

8. A method, comprising:
determining a focus point on a target surface of a part in a region of interest (ROI) by a vision system of a laser marking system having an autofocus module which uses pixel information to obtain a Z-axis focus in a vertical dimension above a two-dimensional (2D) plane;
automatically adjusting, by a controller of the laser marking system, to the focus point in a scanhead of the laser marking system based on the Z-axis focus on the target surface of the part; and
marking, with a laser beam produced by a laser in the scanhead of the laser marking system, a mark on the target surface of the part based on at least the Z-axis focus.

9. The method of claim 8, wherein the vision system is a through-the-lens (TTL) vision system embedded with the laser; and further comprising:
displaying a first window on a display screen, the first window to display a graphical representation of a marking field of a laser, the marking field including an image of the part and the laser is configured to apply the mark anywhere in the marking field;
displaying a second window of a camera view image from within the marking field wherein moving the camera view within the marking field causes mirrors in the scanhead to move such that the part is within the camera view image, the camera view image being generated by the autofocus module; and
receiving selection, adjustment or sizing of a user-identified region of interest (ROI) within the camera view image displayed in the second window, wherein the autofocus module performs image compression of the user-identified ROI to obtain the Z-axis focus relative to the target surface using a focus peak determination algorithm.

10. The method of claim 8, further comprising:
determining, by the laser marking system, a joint photographic experts group (JPEG) compression value as a focus level value based on the pixel information along a plurality of different Z-axis positions; and
determining, by the laser marking system, a peak focus curve from the plurality of different Z-axis positions wherein the Z-axis focus corresponds to a peak focus point on the peak focus curve determined as a location where a slope of a polynomial is zero.

11. The method of claim 8, wherein the vision system determines the Z-axis focus based only on the pixel information.

12. The method of claim 8, wherein the laser marking system comprises a scanhead housing configured to house the scanhead and the laser; and a Z-axis platform comprising a rail assembly coupled to the scanhead housing; and
further comprising:
causing, by the controller, movement of the rail assembly vertically wherein, in response to movement of the rail assembly, the scanhead housing adjusts the Z-axis focus of the laser through the lens relative to the 2D plane.

13. The method of claim 8, wherein the marking system comprises a lens having an optical axis shared by a camera of the vision system and the marking laser; and further comprising:
causing by the controller the optical axis of the lens to adjust the Z-axis focus.

14. A tangible, non-transitory computer readable medium having instructions stored thereon which when executed by at least one processor causes the at least one processor to:
determine a focus point on a target surface of a part, by a vision system of a laser marking system, in a region of interest (ROI) using pixel information to obtain a Z-axis focus wherein the Z-axis focus is in a vertical dimension above a two-dimensional (2D) plane;
cause, by a controller, adjustment to the focus point in a scanhead of the laser marking system based on the Z-axis focus on the target surface of the part; and
cause marking, by a laser in the scanhead of the laser marking system, a mark on the target surface of the part with a laser beam based on at least the Z-axis focus.

15. The tangible, non-transitory computer readable medium of claim 14, wherein the vision system is a through-the-lens (TTL) vision system embedded with the laser.

16. The tangible, non-transitory computer readable medium of claim 14, wherein the instructions when executed causes the at least one processor to further:
determine a joint photographic experts group (JPEG) compression value as a focus level value based on the pixel information along a plurality of different Z-axis positions; and
determine a peak focus curve from the plurality of different Z-axis positions wherein the Z-axis focus corresponds to a peak focus point on the peak focus curve determined as a location where a slope of a polynomial is zero.

17. The tangible, non-transitory computer readable medium of claim 14, wherein the Z-axis focus is based only on the pixel information.

18. The tangible, non-transitory computer readable medium of claim 14, wherein the laser marking system comprises a scanhead housing configured to house the scanhead and the laser; and a Z-axis platform comprising a rail assembly coupled to the scanhead housing; and
wherein the instructions when executed causes the at least one processor to further:
cause the controller to adjust movement of the rail assembly vertically wherein, in response to movement of the rail assembly, the scanhead housing adjusts the Z-axis focus of the laser through a scanhead lens relative to the 2D plane.

19. The tangible, non-transitory computer readable medium of claim 14, wherein the marking system comprises a lens having an optical axis shared by the vision system and the marking laser; and
wherein the instructions when executed causes the at least one processor to further:
cause the controller to control the optical axis of the lens to adjust the Z-axis focus.

20. The tangible, non-transitory computer readable medium of claim 14, wherein the instructions when executed causes the at least one processor to further:
display a first window on a display screen, the first window to display a graphical representation of a marking field of a laser, the marking field including an image of the part and the laser is configured to apply the mark anywhere in the marking field;
display a second window of a camera view image from within the marking field wherein moving the camera view within the marking field causes mirrors in the scanhead to move such that the part is within the camera view image, the camera view image being generated by the autofocus module; and
receive selection, adjustment or sizing of a user-identified region of interest (ROI) within the camera view image displayed in the second window, wherein the autofocus module performs image compression of the user-identified ROI to obtain the Z-axis focus relative to the target surface using a focus peak determination algorithm.

21. The tangible, non-transitory computer readable medium of claim 14, wherein the instructions when executed causes the at least one processor to further:
determine the focus point on the target surface of the part, by a vision system of a laser marking system, during a setup mode or a runtime mode,
wherein during the setup mode, the Z-axis focus is used for a plurality of parts having a similar height to a height of said part; and
during the runtime mode, the Z-axis focus is selectively determined for one or more parts within the marking field.
